(19) United States
(12) Patent Application Publication
(10) Pub. No.: US 2023/0008124 A1
(43) Pub. Date: Jan. 12, 2023

(54) METHOD AND DEVICE FOR ENCODING/DECODING DEEP NEURAL NETWORK MODEL

(71) Applicants: Korea Electronics Technology Institute, Seonganm-si (KR); INDUSTRY-UNIVERSITY COOPERATION FOUNDATION KOAEA AEROSPACE UNIVERSITY, Goyang-si (KR)

(72) Inventors: Byeong Ho CHOI, Seoul (KR); Sang Seol LEE, Gwangju-si (KR); Sung Joon JANG, Seongnam-si (KR); Sung Jei KIM, Seoul (KR); Jae Gon KIM, Goyang-si (KR); Hyeon Cheol MOON, Gwangju (KR)

(73) Assignees: Korea Electronics Technology Institute, Seonganm-si (KR); INDUSTRY-UNIVERSITY COOPERATION FOUNDATION KOAEA AEROSPACE UNIVERSITY, Goyang-si (KR)

(21) Appl. No.: 17/784,856

(22) PCT Filed: Dec. 11, 2020
(86) PCT No.: PCT/KR2020/018140

§ 371 Date: Jun. 13, 2022

(30) Foreign Application Priority Data
Dec. 11, 2019 (KR) 10-2019-0164756
May 22, 2020 (KR) 10-2020-0061583

(51) Int. Cl. G06N 3/04

(52) U.S. Cl. CPC G06N 3/04

(57) ABSTRACT

Disclosed herein are a method and apparatus for encoding/decoding a deep neural network. According to the present disclosure, the method for decoding a deep neural network may include: in a plurality of layers of the deep neural network, entropy decoding quantization information for a current layer; performing dequantization on the current layer; and obtaining a plurality of layers of the deep neural network. At least one of global quantization and local quantization is performed on the current layer.

### BACKGROUND OF THE INVENTION

### Field of the Invention

The present disclosure relates to a deep neural network encoding/decoding method and an apparatus for the same, and more particularly, to a method and apparatus for encoding/decoding a deep neural network by performing quantization/dequantization for a plurality of layers in a deep neural network and entropy encoding/decoding quantization information for the plurality of layers.

### Description of the Related Art

A deep neural network (DNN) is largely composed of processing elements regarded as neurons of the human brain, and the processing elements may include weights of connections between neurons. The purpose of a deep neural network is a process of ‘learning’ that updates the connection weights of neurons according to a given input. Recently, as computational methods for learning deep neural networks are developed, they have begun to be used in various industries, and the performance in each industry has been greatly improved. In addition, in order to graft the deep neural network to various applications, a format including information that can define the learned connection weight and structure of a single deep neural network has been created.

However, in order to be used in various and complex applications, connection weights of multiple layers and complex neurons are required, which results in an increase of computational complexity for deep neural networks. As the computational complexity of the deep neural network increases and the size of the model increases, the necessity of compressing and transmitting information existing in the model is increasing in order to more efficiently apply them to industrial applications.

### SUMMARY

An object of the present disclosure is to provide a method and apparatus for encoding/decoding a deep neural network.

Another object of the present disclosure is to provide a method and apparatus for encoding/decoding a deep neural network by applying global quantization to a plurality of layers of the deep neural network.

Another object of the present disclosure is to provide a method and apparatus for encoding/decoding a deep neural network by applying local quantization to a plurality of layers of the deep neural network.

Another object of the present disclosure is to provide a method and apparatus for encoding/decoding a deep neural network by entropy encoding/decoding quantization information.

Another object of the present disclosure is to provide a method and apparatus for efficiently encoding/decoding a deep neural network.

Other objects and advantages of the present disclosure will become apparent from the description below and will be clearly understood through embodiments of the present disclosure. It is also to be easily understood that the objects and advantages of the present disclosure may be realized by means of the appended claims and a combination thereof.

According to the present disclosure, a method for decoding a deep neural network may be provided, including: in a plurality of layers of the deep neural network, entropy decoding quantization information for a current layer; performing dequantization on the current layer; and obtaining a plurality of layers of the deep neural network, and at least one of global quantization and local quantization is performed on the current layer.

When global quantization is performed on the current layer, the quantization information may include at least one of global quantization mode information on a global quantization mode, bit size information on a bit size, uniform quantization application information on whether or not uniform quantization is applied, individual decoding information on individual decoding of the plurality of layers, parallel decoding information on whether or not parallel decoding is performed, codebook information on a codebook, step size information on a step size, and channel number information on the number of channels in the current layer.

When nonuniform quantization is performed on the current layer, the quantization information may include outlier-aware quantization application information regarding application of an outlier-aware quantization mode.

When the global quantization mode is a special global quantization mode, the quantization information may include transform function list position information regarding a position in a transform function list.

When local quantization is performed on the current layer, the quantization information may include at least one of local quantization application information regarding whether or not local quantization is applied to the entire current layer, sub-block size fix information on whether or not a sub-block size is fixed, sub-block size information on a sub-block size, sub-block local quantization application information regarding whether or not local quantization is applied to a sub-block, local quantization mode information on a local quantization mode, sub-block position information on a sub-block position, sub-block codebook information on a sub-block codebook, and channel number information on the number of channels of the current layer.

When the local quantization mode is a mode for allocating a specific bit, the quantization information may include local quantization bit size information on a local quantization bit size.

The entropy decoding of the quantization information for the current layer may use at least one of a limited K-th order Exp_Golomb binarization method, a fixed-length binarization method, a unary binarization method, and a truncated binary binarization method.

The entropy decoding of the quantization information for the current layer may use, for information generated through binarization, at least one of a context-based adaptive binary arithmetic coding (CABAC) method, a context-based adaptive variable length coding (CAVLC) method, a conditional arithmetic coding method, and a bypass coding method.

A method for encoding a deep neural network may be provided, including: in a plurality of layers of the deep neural network, performing quantization for a current layer; entropy encoding quantization information for the current layer; and generating a bitstream including the quantization information, and at least one of global quantization and local quantization is performed on the current layer.

The entropy encoding of the quantization information for the current layer may use at least one of a limited K-th order Exp_Golomb binarization method, a fixed-length binarization method, a unary binarization method, and a truncated binary binarization method.

The entropy encoding of the quantization information for the current layer may use, for information generated through binarization, at least one of a context-based adaptive binary arithmetic coding (CABAC) method, a context-based adaptive variable length coding (CAVLC) method, a conditional arithmetic coding method, and a bypass coding method.

A computer-readable recording medium, which stores a bitstream that is received and decoded by a deep neural network decoding apparatus and is used to reconstruct the deep neural network, may be provided, and a method for decoding the deep neural network may include: in a plurality of layers of the deep neural network, entropy decoding quantization information for a current layer; performing dequantization on the current layer; and obtaining the current layer, and at least one of global quantization and local quantization is performed on the current layer.

According to the present disclosure, a method and apparatus for encoding/decoding a deep neural network may be provided.

Also, according to the present disclosure, a method and apparatus for encoding/decoding a deep neural network by applying global quantization to a plurality of layers of the deep neural network may be provided.

Also, according to the present disclosure, a method and apparatus for encoding/decoding a deep neural network by applying local quantization to a plurality of layers of the deep neural network may be provided.

Also, according to the present disclosure, a method and apparatus for encoding/decoding a deep neural network by entropy encoding/decoding quantization information may be provided.

Also, according to the present disclosure, a method and apparatus for efficiently encoding/decoding a deep neural network may be provided.

### BRIEF DESCRIPTION OF THE DRAWINGS

FIG. 1 illustrates a decoder structure of a deep neural network model according to an embodiment of the present disclosure.

FIG. 2A illustrates a quantization process according to an embodiment of the present disclosure.

FIG. 2B illustrates an inverse quantization process according to an embodiment of the present disclosure.

FIG. 3 illustrates a sub-block of one layer in a deep neural network according to an embodiment of the present disclosure.

FIG. 4 illustrates a flowchart of performing local quantization according to an embodiment of the present disclosure.

FIG. 5 illustrates global quantization of one layer in a deep neural network according to an embodiment of the present disclosure.

FIG. 6 illustrates local quantization of one layer in a deep neural network according to an embodiment of the present disclosure.

FIG. 7 illustrates a deep neural network decoding flowchart according to an embodiment of the present disclosure.

FIG. 8 illustrates a deep neural network encoding flowchart according to an embodiment of the present disclosure.

### DETAILED DESCRIPTION

A variety of modifications may be made to the present disclosure and there are various embodiments of the present disclosure, examples of which will now be provided with reference to drawings and described in detail. However, the present disclosure is not limited thereto, although the exemplary embodiments can be construed as including all modifications, equivalents, or substitutes in a technical concept and a technical scope of the present disclosure. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the embodiment. The following detailed description is, therefore, not to be taken in a limiting sense, and the scope of the exemplary embodiments is defined only by the appended claims, appropriately interpreted, along with the full range of equivalents to what the claims claim.

Terms used in the present disclosure, ‘first’, ‘second’, etc. may be used to describe various components, but the components are not to be construed as being limited to the terms. The terms are only used to differentiate one component from other components. For example, the ‘first’ component may be named the ‘second’ component without departing from the scope of the present disclosure, and the ‘second’ component may also be similarly named the ‘first’ component. The term ‘and/or’ includes a combination of a plurality of relevant items or any one of a plurality of relevant terms.

When an element is simply referred to as being ‘connected to’ or ‘coupled to’ another element in the present disclosure, it should be understood that the former element is directly connected to or directly coupled to the latter element or the former element is connected to or coupled to the latter element, having yet another element intervening therebetween. In contrast, it should be understood that when an element is referred to as being “directly coupled” or “directly connected” to another element, there are no intervening elements present.

As constitutional parts shown in the embodiments of the present disclosure are independently shown so as to represent characteristic functions different from each other, it does not mean that each constitutional part is a constitutional unit of separated hardware or software. In other words, each constitutional part includes each of enumerated constitutional parts for better understanding and ease of description. Thus, at least two constitutional parts of each constitutional part may be combined to form one constitutional part or one constitutional part may be divided into a plurality of constitutional parts to perform each function. Both an embodiment where each constitutional part is combined and another embodiment where one constitutional part is divided are also included in the scope of the present disclosure, if not departing from the essence of the present disclosure.

The terms used in the present disclosure are merely used to describe particular embodiments, while not being intended to limit the present disclosure. Singular expressions include plural expressions unless the context clearly indicates otherwise. In the present disclosure, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific configuration is referred to as being “included”, other configurations than the configuration are not excluded, but additional elements may be included in the embodiments of the present disclosure or the technical scope of the present disclosure.

In addition, some of constituents may not be indispensable constituents performing essential functions of the present disclosure but be selective constituents improving only performance thereof. The present disclosure may be implemented by including only the indispensable constitutional parts for realizing the essence of the present disclosure except other constituents used merely for improving performance. A structure including only the indispensable constituents except the selective constituents used only for improving performance is also included in the scope of right of the present disclosure.

Hereinafter, embodiments of the present disclosure will be described in detail with reference to the accompanying drawings. In describing exemplary embodiments of the present specification, well-known functions or constructions will not be described in detail since they may unnecessarily obscure the understanding of the present invention. The same constituent elements in the drawings are denoted by the same reference numerals, and a repeated description of the same elements will be omitted.

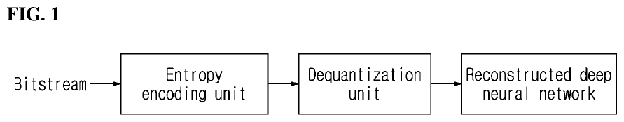

FIG. 1 illustrates a decoder structure of a deep neural network model according to an embodiment of the present disclosure. A deep neural network may have M positive integer layers. One layer among the plurality of layers of the deep neural network may have N positive integer dimensions (channels). In addition, one layer of the deep neural network may correspond to a learned weight matrix having one dimension. Also, one layer of the deep neural network may correspond to a learned weight matrix having two dimensions. Also, one layer of the deep neural network may correspond to a learned weight matrix having three dimensions. In addition, one layer of the deep neural network may correspond to a learned weight matrix having four dimensions.

In a quantization step of a deep neural network, one layer of the deep neural network may be reshaped into blocks that have X positive integer dimensions. Herein, the positive integer X should be smaller than the positive integer N, which is the number of dimensions of one layer of a plurality of layers of the deep neural network. As an example, when one layer of a plurality of layers of the deep neural network is a matrix having four dimensions, it may be a block having two dimensions through reshaping. However, the present invention is not limited to the above embodiment.

Referring to FIG. 1 , a deep neural network decoder may include an entropy decoding unit and a dequantization unit. A bitstream may be generated by encoding a deep neural network. The bitstream may be transmitted to the decoder. For the bitstream transmitted to the decoder, entropy decoding may be performed in the entropy decoding unit. Then, dequantization may be performed in the dequantization unit. Then, it may be reconstructed to the deep neural network.

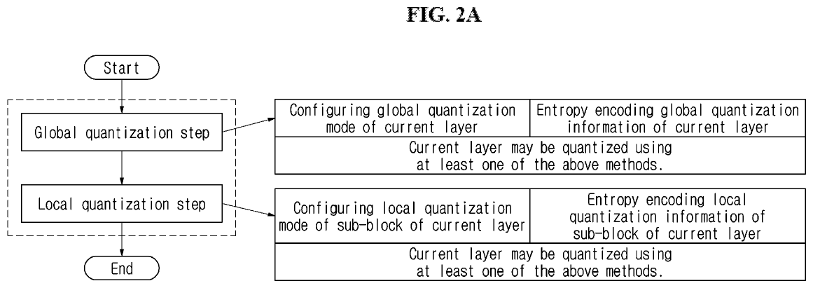

FIG. 2A illustrates a quantization process according to an embodiment of the present disclosure.

Referring to FIG. 2A, when quantization on a current layer is performed in a plurality of layers of a deep neural network, global quantization and local quantization may be performed on the current layer. In addition, global quantization alone may be performed on the current layer. In addition, local quantization alone may be performed on the current layer. When global quantization is performed on the current layer, a global quantization mode may be configured in the current layer. In addition, global quantization information of the current layer may be entropy encoded. The current layer may be quantized by using at least one or more methods of global quantization mode configuration and global quantization information entropy encoding.

When local quantization is performed on the current layer, a local quantization mode may be configured in a sub-block of the current layer. In addition, local quantization information of the sub-block of the current layer may be entropy encoded. The current layer may be quantized by using at least one or more methods of local quantization mode configuration and local quantization information entropy encoding.

FIG. 2B illustrates an inverse quantization process according to an embodiment of the present disclosure.

Referring to FIG. 2B, when dequantization on a current layer is performed in a plurality of layers of a deep neural network, global dequantization and local dequantization may be performed on the current layer. In addition, global dequantization alone may be performed on the current layer. In addition, local dequantization alone may be performed on the current layer. When global dequantization is performed on the current layer, a global quantization mode may be configured in the current layer. In addition, global quantization information of the current layer may be entropy decoded. The current layer may be dequantized by using at least one or more methods of global quantization mode configuration and global quantization information entropy decoding.

When local dequantization is performed on the current layer, a local quantization mode may be configured in a sub-block of the current layer. In addition, local quantization information of the sub-block of the current layer may be entropy decoded. The current layer may be dequantized by using at least one or more methods of local quantization mode configuration and local quantization information entropy decoding.

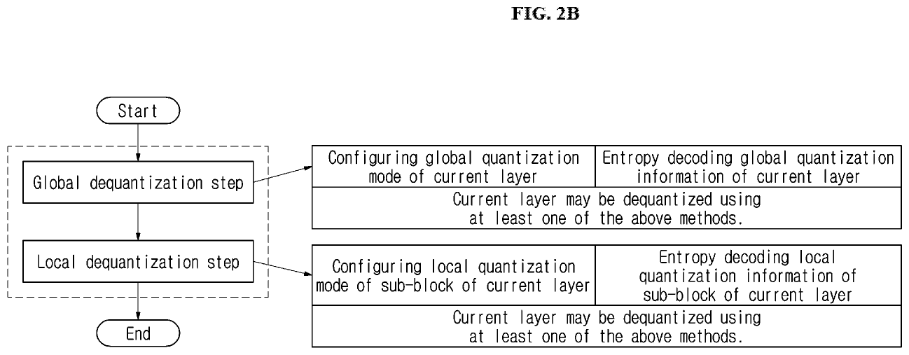

FIG. 3 illustrates a sub-block of one layer in a deep neural network according to an embodiment of the present disclosure.

Referring to FIG. 3, one layer in a deep neural network may include a plurality of blocks. In addition, one layer in a deep neural network may include a plurality of sub-blocks. Each sub-block may include a plurality of blocks. As an example, a sub-block may correspond to a 2 x 2 block unit. As an example, a sub-block may correspond to a 4 x 4 block unit. As an example, a sub-block may correspond to an 8 x 8 block unit. However, the present invention is not limited to the above embodiment.

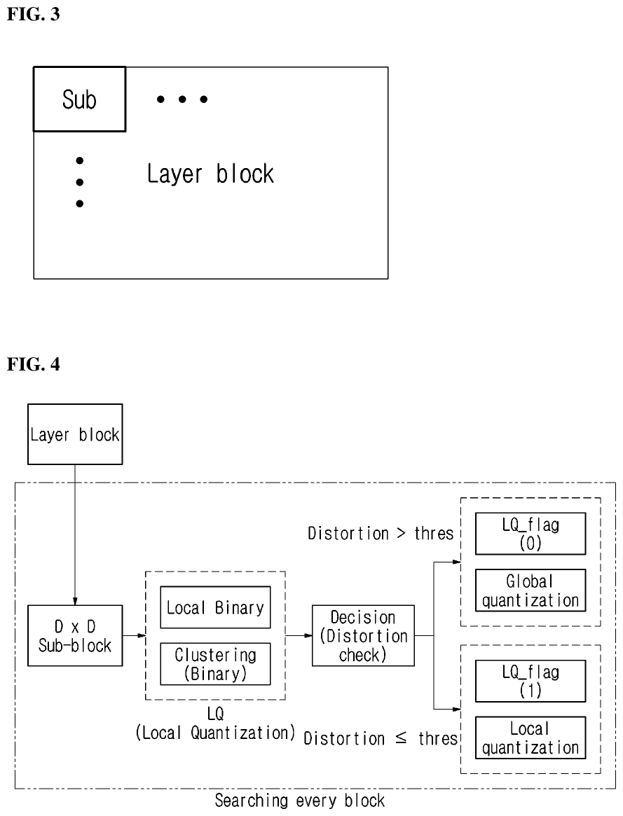

FIG. 4 illustrates a flowchart of performing local quantization according to an embodiment of the present disclosure.

Referring to FIG. 4, when local quantization is performed on one layer of a deep neural network, all blocks in the one layer may be searched. Local quantization may be performed on a sub-block that is included in one layer. A local quantization mode may be determined in a sub-block. In addition, the local quantization mode may correspond to at least one of a local binary mode and a binary clustering mode. In addition, whether or not to apply local quantization may be determined through a distortion test. When a degree of distortion is greater than a predetermined threshold, local quantization may not be performed (LQ_flag=0) but global quantization may be performed. In addition, when a degree of distortion is smaller than or equal to a predetermined threshold, local quantization may be performed (LQ_flag=1).

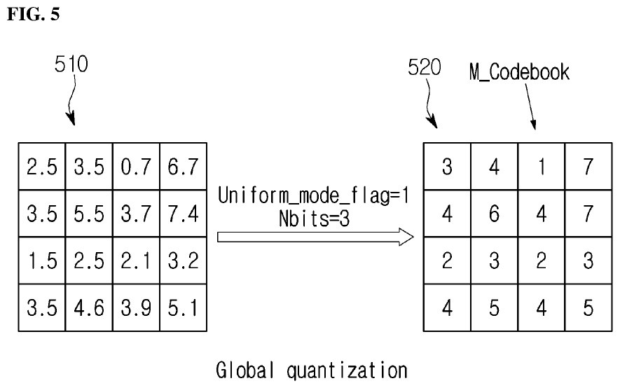

FIG. 5 illustrates global quantization of one layer in a deep neural network according to an embodiment of the present disclosure. When global quantization is performed on a current layer in a plurality of layers of a deep neural network, information on a global quantization mode ay be signaled. Information on the size of a global quantization bit may be signaled. In addition, information indicating whether or not uniform quantization is applied (e.g., uniform_mode_flag) may be signaled. When uniform quantization is applied, information indicating whether or not uniform quantization is applied (e.g., uniform_mode_flag) may indicate 1. When uniform quantization is not applied, information indicating whether or not uniform quantization is applied (e.g., uniform_mode_flag) may indicate 0. In this case, indicator information specifying a nonuniform quantization mode may be signaled. As an example, it may correspond to a nonuniform/nonlinear mode. As an example, it may correspond to an outlier-aware mode. As an example, it may correspond to a dependent quantization mode. However, the present invention is not limited to the above embodiment. In addition, codebook information according to a bit size and step size information (e.g., step_size) may be signaled. In addition, information regarding whether or not parallel decoding is applied for efficient decoding may be signaled (e.g., parallel_decoding_flag). Herein, when parallel decoding is applied (e.g., parallel_decoding_flag=1), quantization and entropy decoding may be performed in parallel in column or row units. Herein, in the case of a dependent quantization mode, state list information (e.g., dependent_state_list) may be signaled in column or row units. In addition, in the case of context-adaptive binary arithmetic coding, context information (e.g., cabac_contex_list) may also be signaled in column or row units.

When global quantization is performed on a current layer, the current layer may be quantized/dequantized using at least one of a method using a global quantization mode and a global quantization information entropy encoding/decoding method. When global quantization is performed on a current layer, bit size information to be input may be signaled. Alternatively, step size information (e.g., step_size) may be signaled. In addition, in a plurality of layers of a deep neural network, information indicating whether or not individual decoding is performed for each layer (e.g., layer_independently_flag) may be signaled. The size of a current layer may correspond to N positive integer dimensions. When a current layer is reshaped, the sizes of an original dimension of the current layer and a dimension after reshaping may be signaled. As an example, a 4-dimensional (N=4) layer matrix may be reshaped to a 2-dimensional matrix. However, the present invention is not limited to the above embodiment. In addition, quantization techniques applied to a current layer may be distinguished through an indicator for distinguishing between a case of performing global quantization on a current and a case of not performing global quantization on a current layer. In addition, quantization techniques applied to a current layer may be distinguished through an indicator for distinguishing between a case of performing local quantization on a current and a case of not performing local quantization on a current layer.

Global quantization may mean that quantization is performed by applying a same quantization parameter to all blocks of a current layer. A global quantization mode may correspond to at least one of various modes like uniform/linear quantization, nonuniform/nonlinear quantization and outlier-aware quantization. Herein, as for a general global quantization mode, at least one or more quantization modes of uniform quantization and nonuniform quantization may be defined as a general global quantization mode. In addition, as for a special global quantization mode, at least one or more quantization modes among global quantization modes excluding general global quantization modes like uniform quantization and nonuniform quantization may be defined as a special global quantization mode.

When a global quantization mode is configured in a current layer, a predetermined specific mode indicator may be used. When it corresponds to a special global quantization mode, a transform function list candidate may be configured. As an example, in the case of outlier-aware quantization, a transform function list may be configured as {Non-DCT, DCT-2, DCT-8, . . . }.

Global quantization information of a current layer may be entropy encoded/decoded. A quantization result value and information of global quantization may be signaled. As an example, when uniform quantization is applied, a quantization value of each element and step size information (e.g., step_size) may be signaled. As an example, when nonuniform quantization is applied, a quantization value of each element and codebook information may be signaled. An indicator indicating whether or not a global quantization mode matches a specific mode may be signaled. As an example, when a specific mode is uniform quantization, information indicating whether or not uniform quantization is applied (e.g., uniform_mode_flag) may indicate 1. As an example, when a specific mode is nonuniform quantization, information indicating whether or not uniform quantization is applied (e.g., uniform_mode_flag) may indicate 0. In addition, in the case of nonuniform quantization, information (e.g., nonuniform_idx) regarding whether to perform nonuniform quantization alone or to perform outlier-aware quantization may be signaled. As an example, when nonlinear quantization is performed, information (e.g., nonuniform_idx) regarding whether to perform nonuniform quantization alone or to perform outlier-aware quantization may indicate 0. As an example, when outlier-aware (nonuniform/nonlinear) quantization is performed, information (e.g., nonuniform_idx) regarding whether to perform nonuniform quantization alone or to perform outlier-aware quantization may indicate 1. As an example, when outlier-aware quantization is performed, if uniform quantization is performed for an outlier and nonuniform quantization is performed for a value that is not an outlier, information (e.g., nonuniform_idx) regarding whether to perform nonuniform quantization alone or to perform outlier-aware quantization may indicate 2. As an example, when outlier-aware quantization is performed, if nonuniform quantization is performed for an outlier and uniform quantization is performed for a value that is not an outlier, information (e.g., nonuniform_idx) regarding whether to perform nonuniform quantization alone or to perform outlier-aware quantization may indicate 3. However, the present invention is not limited to the above embodiment.

When global quantization uses two or more specific modes, index information designating a selected mode may be signaled. In the case of a special global quantization mode, index information (e.g., transform_idx) designating a position in a transform function list may be signaled. In addition, index information (e.g., nchannel_idx) indicating the number of channels of a current layer may be signaled. In addition, index information (e.g., overall_Pbit) indicating a global quantization bit number of a current layer may be signaled.

When entropy encoding/decoding global quantization information, at least one of a limited K-th order Exp_Golomb binarization method, a fixed-length binarization method, a unary binarization method, and a truncated binary binarization method may be used. In addition, when entropy encoding/decoding binary information that is generated through binarization, at least one or more methods among context-adaptive binary arithmetic coding (CABAC), context-adaptive variable length coding (CAVLC), conditional arithmetic coding and bypass coding may be used.

Referring to FIG. 5, global quantization may be applied to a current layer 510. The current layer 510 may include a 4×4 block. In addition, uniform quantization may be applied to the current layer 510. Accordingly, information indicating whether or not uniform quantization is applied (e.g., uniform_mode_flag) may indicate 1. A bit number of global quantization may correspond to 3. Quantization may be performed by applying a same quantization parameter for all blocks of the current layer 510. As global quantization is performed, the current layer 510 may quantized into a layer 520 subsequent to performing the global quantization. In addition, such global quantization information may be entropy encoded/decoded.

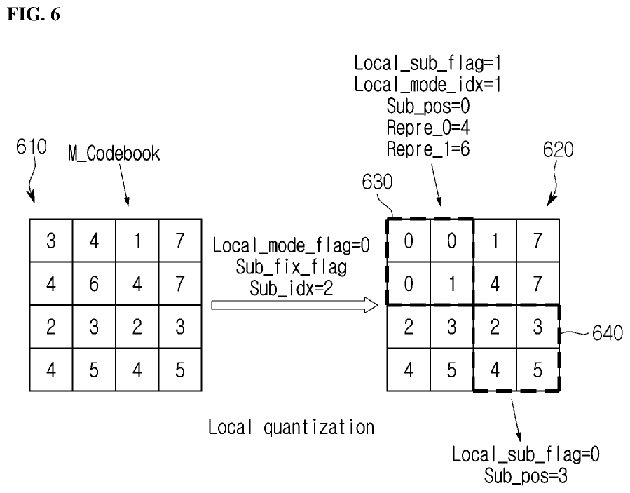

FIG. 6 illustrates local quantization of one layer in a deep neural network according to an embodiment of the present disclosure. In the case of local quantization, information (e.g., local_mode_flag) indicating whether or not local quantization is applied to an entire current layer may be signaled. When local quantization is performed on an entire current layer, information (e.g., local_mode_flag) indicating whether or not local quantization is applied to an entire current layer may indicate 1. When local quantization is not performed on an entire current layer, information (e.g., local_mode_flag) indicating whether or not local quantization is applied to an entire current layer may indicate 0. In addition, size fix information of a sub-block (e.g., sub_fix_flag), in which local quantization is performed), may be signaled. In addition, size information of a sub-block (e.g., sub_idx), in which local quantization is performed, may be signaled. Size information of a sub-block (e.g., sub_idx), in which local quantization is performed, may be defined in a table form. As an example, when size information of a sub-block (e.g., sub_idx), in which local quantization is performed, is 0, it may correspond to a 2×2 block unit. As an example, when size information of a sub-block (e.g., sub_idx), in which local quantization is performed, is 1, it may correspond to a 4×4 block unit. As an example, when size information of a sub-block (e.g., sub_idx), in which local quantization is performed, is 2, it may correspond to an 8×8 block unit. However, the present invention is not limited to the above embodiment.

Information (e.g., local_sub_flag) indicating whether or not local quantization is applied to a corresponding sub-block may be signaled. In addition, index information (e.g., local_mode_idx) of a local quantization mode may be signaled. In addition, position information (e.g., sub_pos) of a sub-block may be signaled. In addition, codebook information (e.g., repre_c) regarding local quantization may be signaled.

When local quantization is performed on a current layer, the current layer may be quantized/dequantized using at least one of a method using a local quantization mode and a local quantization information entropy encoding/decoding method. Local quantization may be performed in a sub-block unit in a current layer. A local quantization mode may correspond to at least one of various modes like overall non-local quantization, local binary, and binary clustering. Herein, as for a general local quantization mode, at least one of uniform quantization and nonuniform quantization may be defined as a general local quantization mode. An overall non-local quantization mode may be defined as a special local quantization mode. In the case of an overall non-local quantization mode, information (e.g., local_mode_flag) indicating whether or not local quantization is applied to an entire current layer may indicate 0.

A size of a sub-block may correspond to A×B, and A and B may correspond to positive integer values respectively. In addition, A and B may correspond to a common divisor of block sizes of a current layer. As an example, when a current layer is 64×64 in size, A and B of a sub-block A×B may correspond to one of 16, 8, 4 and 2. A size of a sub-block may be fixed. In addition, a size of a sub-block may correspond to an adaptive form. Size information of a sub-block (e.g., sub_idx), in which local quantization is performed, may selected from an index of a common divisor list of block sizes of a current layer. When a size of a sub-block has an adaptive form, a size candidate of the sub-block may be included in a common divisor list of block sizes of a current layer. In addition, codebook information of a sub-block may be signaled. Representative values in a codebook may each be determined by methods like RD optimization and an average value of the values. A size of a codebook is different according to a size of a set bi (=D) of local binarization, and a representative value in each codebook may be transmitted in a sub-block unit.

When a local quantization mode is configured in a sub-block of a current layer, a predetermined specific mode indicator may be used. A local quantization mode may be signaled in an entire layer unit. As an example, when local quantization is performed on an entire current layer, information (e.g., local_mode_flag) indicating whether or not local quantization is applied to an entire current layer may indicate 1. As an example, when local quantization is not performed on an entire current layer, information (e.g., local_mode_flag) indicating whether or not local quantization is applied to an entire current layer may indicate 0. A local quantization mode may be signaled in a sub-block unit. A local and clustering mode is not limited to binarization and may be performed in a bit greater than 1 bit. As an example, an overall non-local quantization mode may be performed for a corresponding sub-block. As an example, a local quantization mode may be performed for a corresponding sub-block. As an example, a local binarization mode may be performed for a corresponding sub-block. As an example, a local D bit mode may be performed for a corresponding sub-block. Herein, a D bit should be smaller than a size of P bit of a global quantization mode. As an example, a binary clustering mode may be performed for a corresponding sub-block. However, the present invention is not limited to the above embodiment.

Codebook information and the like generated according to implementation of local quantization may be signaled. A size of a codebook may be set according to a local quantization mode. As an example, when a local quantization mode is a binarization mode, a size of a codebook may indicate 1. When a local quantization mode is a binary clustering mode, a bit size may be determined with no necessity to separately signal a size of a codebook. When a local quantization mode should set a separate bit size, separate bit size information (e.g., local_dbits_idx) may be signaled. Codebook information (e.g., repre_c) regarding local quantization may be determined according to a size of a codebook. Herein, the size of a codebook should be smaller than a global quantization bit size. Each codebook may be determined by various methods like RD optimization and an average value of original kernel values.

Local quantization information may be entropy encoded/decoded in a sub-block of a current layer. It may be entropy encoded/decoded in an entire current layer unit. Information regarding whether or not local quantization is performed in an entire current layer may be signaled. As an example, when local quantization is performed on an entire current layer, information (e.g., local_mode_flag) indicating whether or not local quantization is applied to an entire current layer may indicate 1. As an example, when local quantization is not performed on an entire current layer, information (e.g., local_mode_flag) indicating whether or not local quantization is applied to an entire current layer may indicate 0. Information on a sub-block may be signaled. As an example, when a size of a sub-block is fixed, size fix information (e.g., sub_fix_flag) of the sub-block may indicate 1. In addition, size information (e.g., sub_idx) of a sub-block may be signaled.

When local quantization of a current layer is entropy encoded/decoded, entropy encoding/decoding may be performed in a sub-block unit. An indicator indicating whether or not local quantization matches a specific mode may be signaled. As an example, when a specific mode is a local quantization mode, information (e.g., local_sub_flag) indicating whether or not local quantization is performed in a corresponding sub-block may indicate 1. As an example, when a specific mode is a binarization mode, index information (e.g., local_mode_idx) of a local quantization mode may indicate 0. As an example, when a specific mode is a binary clustering mode, index information (e.g., local_mode_idx) of a local quantization mode may indicate 1. As an example, when a specific mode is a local D-bit quantization mode, index information (e.g., local_mode_idx) of a local quantization mode may indicate 2. In this case, separate bit size information (e.g., local_dbits_idx) may be signaled. Herein, a D bit should be smaller than a size of a global quantization bit. As an example, when a specific mode is an overall non-local quantization mode, information (e.g., local_sub_flag) indicating whether or not local quantization is performed in a corresponding sub-block may indicate 0. In addition, position information (e.g., sub_pos) of a sub-block may be signaled. In addition, codebook information (e.g., repre_c) regarding local quantization may be signaled. In addition, index information (e.g., reshaping mode_idx) indicating a reshaping mode may be signaled. In addition, index information (e.g., nchannel_idx) indicating the number of channels in a corresponding layer may be signaled.

When entropy encoding/decoding local quantization information, at least one of a limited K-th order Exp_Golomb binarization method, a fixed-length binarization method, a unary binarization method, and a truncated binary binarization method may be used. In addition, when entropy encoding/decoding binary information that is generated through binarization, at least one or more methods among context-adaptive binary arithmetic coding (CABAC), context-adaptive variable length coding (CAVLC), conditional arithmetic coding and bypass coding may be used. In addition, when entropy encoding/decoding binary information that is generated through binarization, the entropy encoding/decoding may be adaptively performed using at least one or more pieces of encoding information among prediction information of a neighboring layer, a probability model, and a size of a sub-block for local binarization. As an example, when prediction information of a current layer is encoded/decoded, a context model of prediction information of a current block may be used differently according to syntax information of a neighboring layer that is already encoded/decoded.

Referring to FIG. 6, local quantization may be performed on a current layer 610. As local quantization is not performed on an entire current layer, information (e.g., local_mode_flag) indicating whether or not local quantization is applied to an entire current layer may indicate 0. In addition, since a size of a sub-block, in which local quantization is performed, is a 2×2 block unit, size information (e.g., sub_idx) of a sub-block in which local quantization is performed may indicate 2. However, when size information (e.g., sub_idx) of a sub-block in which local quantization is performed is defined in a table form, size information (e.g., sub_idx) of a sub-block in which local quantization is performed may indicate 0. Local quantization may be performed in a 2×2 sub-block 630 located at upper left in a layer 620 for which local quantization is performed. Accordingly, information (e.g., local_sub_flag) indicating whether or not local quantization is performed in the sub-block 630 may indicate 1. In addition, the local quantization mode in the sub-block 630 may correspond to a binary clustering mode. Accordingly, index information (e.g., local_mode_idx) of a local quantization mode in the sub-block 630 may indicate 1. Since the sub-block 630 is located at upper left of a current layer, position information (e.g., sub_pos) of the sub_block 630 may indicate 0. As binarization is applied according to a binary clustering mode, codebook information (e.g., repre_c) for local quantization of the sub-block 630 may indicate 0 or 1.

Local quantization may not be performed in a 2×2 sub-block 640 located at lower right in the layer 620 for which local quantization is performed. Accordingly, information (e.g., local_sub_flag) indicating whether or not local quantization is performed in the sub-block 640 may indicate 0. Since the sub-block 640 is located at lower right of a current layer, position information (e.g., sub_pos) of the sub_block 640 may indicate 3. In addition, such local quantization information may be entropy encoded/decoded.

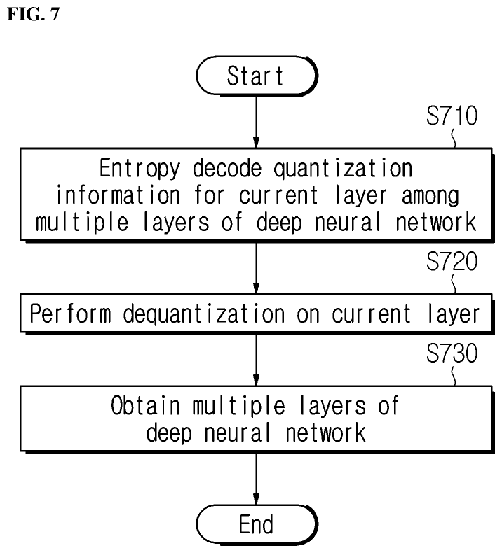

FIG. 7 illustrates a deep neural network decoding flowchart according to an embodiment of the present disclosure.

Referring to FIG. 7, in a plurality of layers of a deep neural network, quantization information for a current layer may be entropy decoded (S710).

According to an embodiment, at least one of global quantization and local quantization may be performed on a current layer.

According to an embodiment, quantization information may include at least one of global quantization mode information on a global quantization mode, bit size information on a bit size, uniform quantization application information regarding whether or not uniform quantization is applied, individual decoding information on individual decoding of the plurality of layers, parallel decoding information regarding whether or not parallel decoding is performed, codebook information on a codebook, step size information on a step size, and channel number information on the number of channels of a current layer.

According to an embodiment, when nonuniform quantization is performed on a current layer, quantization information may include outlier-aware quantization application information regarding application of an outlier-aware quantization mode.

According to an embodiment, when a global quantization mode is a special global quantization mode, quantization information may include transform function list position information regarding a position in a transform function list.

According to an embodiment, when local quantization is performed on a current layer, quantization information may include at least one of local quantization application information regarding whether or not local quantization is applied to the entire current layer, sub-block size fix information regarding whether or not a sub-block size is fixed, sub-block size information on a sub-block size, sub-block local quantization application information on whether or not to apply local quantization to a sub-block, local quantization mode information on a local quantization mode, sub-block position information on a sub-block position, sub-block codebook information on a sub-block codebook, and channel number information on the number of channels of a current layer.

According to an embodiment, when a local quantization mode is a mode for allocating a specific bit, quantization information may include local quantization bit size information on a local quantization bit size.

According to an embodiment, a step of entropy decoding quantization information for a current layer may use at least one of a limited K-th order Exp_Golomb binarization method, a fixed-length binarization method, a unary binarization method, and a truncated binary binarization method.

According to an embodiment, a step of entropy decoding quantization information for the current layer may use, for information generated through binarization, at least one of a context-based adaptive binary arithmetic coding (CABAC) method, a context-based adaptive variable length coding (CAVLC) method, a conditional arithmetic coding method, and a bypass coding method.

In addition, dequantization may be performed on a current layer (S720).

In addition, a plurality of layers of a deep neural network may be obtained (S730).

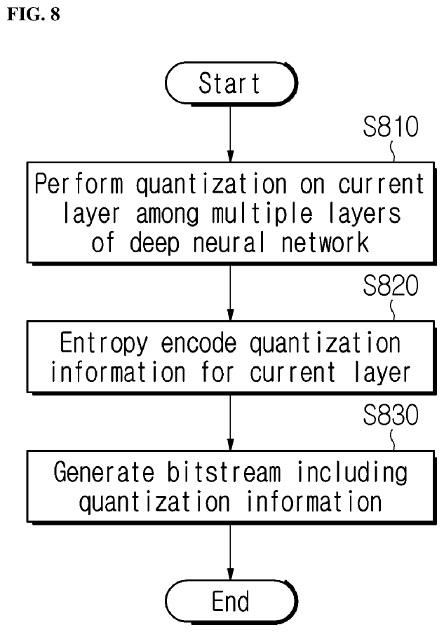

FIG. 8 illustrates a deep neural network encoding flowchart according to an embodiment of the present disclosure.

Referring to FIG. 8, in a plurality of layers of a deep neural network, quantization may be performed on a current layer (S810).

According to an embodiment, at least one of global quantization and local quantization may be performed on a current layer.

According to an embodiment, a step of entropy encoding quantization information for a current layer may use at least one of a limited K-th order Exp_Golomb binarization method, a fixed-length binarization method, a unary binarization method, and a truncated binary binarization method.

According to an embodiment, a step of entropy encoding quantization information for the current layer may use, for information generated through binarization, at least one of a context-based adaptive binary arithmetic coding (CABAC) method, a context-based adaptive variable length coding (CAVLC) method, a conditional arithmetic coding method, and a bypass coding method.

In addition, quantization information for the current layer may be entropy encoded (S820).

In addition, a bitstream including quantization information may be generated (S830).

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The embodiments of the present disclosure may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the disclosure.

What is claimed is:

1. A method for decoding a deep neural network, the method comprising:
in a plurality of layers of the deep neural network, entropy decoding quantization information for a current layer;
performing dequantization on the current layer; and
obtaining a plurality of layers of the deep neural network,
wherein at least one of global quantization and local quantization is performed on the current layer.

2. The method of claim 1, wherein, when global quantization is performed on the current layer, the quantization information includes at least one of global quantization mode information on a global quantization mode, bit size information on a bit size, uniform quantization application information regarding whether or not uniform quantization is applied, individual decoding information on individual decoding of the plurality of layers, parallel decoding information regarding whether or not parallel decoding is performed, codebook information on a codebook, step size information on a step size, and channel number information on a number of channels in the current layer.

3. The method of claim 2, wherein, when nonuniform quantization is performed on the current layer, the quantization information includes outlier-aware quantization application information regarding application of an outlier-aware quantization mode.

4. The method of claim 2, wherein, when the global quantization mode is a special global quantization mode, the quantization information includes transform function list position information regarding a position in a transform function list.

5. The method of claim 1, wherein, when local quantization is performed on the current layer, the quantization information includes at least one of local quantization application information regarding whether or not local quantization is applied to the entire current layer, sub-block size fix information regarding whether or not a sub-block size is applied, sub-block size information on a sub-block size, sub-block local quantization application information regarding whether or not local quantization is applied to a sub-block, local quantization mode information on a local quantization mode, sub-block position information on a sub-block position, sub-block codebook information on a sub-block codebook, and channel number information on a number of channels of the current layer.

6. The method of claim 5, wherein, when the local quantization mode is a mode for allocating a specific bit, the quantization information includes local quantization bit size information on a local quantization bit size.

7. The method of claim 1, wherein the entropy decoding of the quantization information for the current layer uses at least one of a limited K-th order Exp_Golomb binarization method, a fixed-length binarization method, a unary binarization method, and a truncated binary binarization method.

8. The method of claim 7, wherein the entropy decoding of the quantization information for the current layer uses, for information generated through binarization, at least one of a context-based adaptive binary arithmetic coding (CABAC) method, a context-based adaptive variable length coding (CAVLC) method, a conditional arithmetic coding method, and a bypass coding method.

9. A method for encoding a deep neural network, the method comprising:
in a plurality of layers of the deep neural network, performing quantization for a current layer;
entropy encoding quantization information for the current layer; and
generating a bitstream including the quantization information,
wherein at least one of global quantization and local quantization is performed on the current layer.

10. The method of claim 9, wherein the entropy encoding of the quantization information for the current layer uses at least one of a limited K-th order Exp_Golomb binarization method, a fixed-length binarization method, a unary binarization method, and a truncated binary binarization method.

11. The method of claim 10, wherein the entropy encoding of the quantization information for the current layer uses, for information generated through binarization, at least one of a context-based adaptive binary arithmetic coding (CABAC) method, a context-based adaptive variable length coding (CAVLC) method, a conditional arithmetic coding method, and a bypass coding method.

12. A computer-readable recording medium storing a bitstream that is received and decoded by a deep neural network decoding apparatus and is used to reconstruct a deep neural network, wherein a method for decoding the deep neural network comprises:
in a plurality of layers of the deep neural network, entropy decoding quantization information for a current layer;
performing dequantization on the current layer; and
obtaining the current layer, and
wherein at least one of global quantization and local quantization is performed on the current layer.
